(19) United States
(12) Patent Application Publication
(10) Pub. No.: US 2013/0259279 A1
(43) Pub. Date: Oct. 3, 2013

(54) HEARING INSTRUMENT WITH FLEXIBLE EARPIECE TUBE CONNECTION, EARPIECE, AND HOUSING

(71) Applicant: SIEMENS MEDICAL INSTRUMENTS PTE. LTD., Singapore (SG)

(72) Inventor: AUN YONG HONG, JOHOR BAHRU (MY)

(73) Assignee: SIEMENS MEDICAL INSTRUMENTS PTE. LTD., Singapore (SG)

(21) Appl. No.: 13/852,267

(22) Filed: Mar. 28, 2013

(30) Foreign Application Priority Data
Mar. 28, 2012 (DE) 10 2012 205 011.6

(51) Int. Cl. H04R 25/00

(52) U.S. Cl. CPC H04R 25/65
USPC 381/322

(57) ABSTRACT

A hearing instrument to be worn behind or in the auricle, has an external earpiece, worn in the auditory canal and is connected by an earpiece tube to the hearing instrument housing. The hearing instrument has a flexible adjustability of the earpiece tube connection both in length and in rotational position. The hearing system has a housing, an earpiece, and an earpiece tube connected to the housing and the earpiece, with an earpiece tube connector connecting a housing-side segment of the earpiece tube to an earpiece-side segment of the earpiece tube. The earpiece tube connector forms an electrically conducting connection that is mechanically stable in respect of release and allows variable and reversible longitudinal displacement and rotation of the two segments in relation to one another. The earpiece tube connector, by the housing and earpiece being connected is therefore disposed in-line in the earpiece tube. It establishes both the electrical and the mechanical connection between housing and earpiece.

### CROSS-REFERENCE TO RELATED APPLICATION

This application claims the priority, under 35 U.S.C. §119, of German application DE 10 2012 205 011.6, filed Mar. 28, 2012; the prior application is herewith incorporated by reference in its entirety.

### BACKGROUND OF THE INVENTION

### Field of the Invention

The invention relates to a hearing instrument to be worn behind or in or on the auricle, having an external earpiece, which is worn in the auditory canal and is connected by way of an earpiece tube to the hearing instrument housing. The earpiece tube here can be adjusted flexibly both in respect of length and also in respect of rotation.

Hearing instruments can be embodied for example as hearing devices. A hearing device serves to supply a hearing-impaired person with acoustic ambient signals, which are processed and amplified to compensate for or treat the respective hearing impairment. It basically consists of one or more input transducers, a signal processing facility, an amplification facility and an output transducer. The input transducer is generally a sound receiver, e.g. a microphone and/or an electromagnetic receiver, e.g. an induction coil. The output transducer is generally implemented as an electroacoustic converter, e.g. a miniature loudspeaker, or as an electromechanical converter, e.g. bone conduction earpiece. It is also referred to as an earpiece or receiver. The output transducer generates output signals, which are conducted to the ear of the patient with the aim of producing auditory perception in the patient. The amplifier is generally integrated in the signal processing facility. Power is supplied to the hearing device by a battery integrated in the hearing device housing. The key components of a hearing device are generally disposed on a printed circuit board as the circuit support or connected thereto.

Hearing instruments can not only be embodied as hearing devices but also as what are known as tinnitus maskers. Tinnitus maskers are used to treat tinnitus patients. They generate acoustic output signals as a function of the respective hearing impairment and also, depending on the operating principle, as a function of ambient noise, the acoustic output signals being able to help reduce the perception of interfering tinnitus or other ear noises.

Hearing devices are known in various basic housing configurations. In the case of ITE (in the ear) hearing devices a housing, which contains all the functional components, including microphone and receiver, is largely worn in the auditory canal. CIC (completely in canal) hearing devices are like ITE hearing devices but are worn completely in the auditory canal. In the case of BTE (behind the ear) hearing devices a housing with components such as battery and signal processing facility is worn behind the ear and a flexible sound tube conducts the acoustic output signals of a receiver from the housing to the auditory canal, where an ear mold is frequently provided on the tube for the reliable positioning of the tube end in the auditory canal. RIC-BTE (receiver in canal behind the ear) hearing devices are like BTE hearing devices but the receiver is worn in the auditory canal and in place of a sound tube a flexible earpiece tube conducts electrical signals instead of acoustic signals to the receiver, which is positioned at the front on the earpiece tube, generally in an ear mold for ensuring reliable positioning in the auditory canal. RIC-BTE hearing devices are frequently used as so-called open-fit devices, in which the auditory canal remains open for the passage of sound and air to reduce the interfering occlusion effect.

Deep ear canal hearing devices are like CIC hearing devices. However while CIC hearing devices are generally worn in the outside part of the outer auditory canal, deep ear canal hearing devices are pushed further toward the eardrum and are worn at least partially in the inside part of the outer auditory canal. The outer (distal) auditory canal is a skin-lined canal connecting the auricle to the eardrum. In the outer part of the auditory canal, which directly adjoins the auricle, the canal is formed from elastic cartilage. In the inner (proximal) part the canal is formed by the temporal bone and therefore consists of bone. The course of the auditory canal between the cartilaginous and bony parts is generally slightly kinked and forms an angle that varies from person to person. In particular the bony part of the auditory canal is relatively sensitive to pressure and touch. Deep ear canal hearing devices are worn at least partially in the sensitive bony part of the auditory canal. When they are pushed forward into the bony part of the auditory canal they also have to pass the abovementioned kink, which can be problematic, depending on the angle of the kink. Also small diameters and twisted shapes of the auditory canal further complicate forward movement.

All the housing configurations have in common the fact that the aim is to reduce the size of the housing as much as possible, to increase wearer comfort and reduce the visibility of the hearing device for cosmetic reasons.

Hearing instruments can also be embodied as telephones, mobile telephones, headsets, headphones, MP3 players or other telecommunication systems or electronic entertainment systems.

In the following the term hearing instrument refers to hearing devices, as well as tinnitus maskers and similar such devices, telecommunication systems and electronic entertainment systems.

In the case of hearing instruments worn behind or in or on the auricle, having an earpiece worn in the auditory canal, which is connected by way of an earpiece tube to the hearing instrument housing, it is desirable to be able to make individual adjustments to the ear shape and auditory canal shape of the user. Although an earpiece tube is generally already elastic per se and can therefore be adjusted flexibly to a certain extent, it may be advantageous to increase flexibility. Increased flexibility may be necessary for example for wearer comfort, it may assist with more effective fixing in particular of the earpiece in the auditory canal or it may allow favorable positioning of the hearing instrument housing and earpiece. It is therefore desirable to be able to adjust both the length and the inherent rotation of the earpiece tube in a flexible manner.

The absence of the adjustment option makes it necessary to stock a plurality of earpiece tubes of different length and with different inherent rotations, in order to be able to meet individually different user needs and hearing instrument requirements as well as the different configuration for right and left ears.

U.S. Pat. No. 4,727,582 discloses a BTE hearing device, which has an earpiece connected by way of an earpiece tube. The earpiece tube consists of two segments, which can be displaced longitudinally in relation to one another. The length of the electric cable inside is managed in that the projecting segment of the cable is accommodated in a reservoir in the housing of the hearing instrument. The earpiece tube together with earpiece is mounted in the housing of the hearing instrument.

U.S. Pat. No. 7,844,065 B2 discloses a BTE hearing device, which has an earpiece connected by way of an electric cable. The cable is not enclosed by an earpiece tube and can be pushed to varying degrees into the housing of the hearing instrument. Provided in the interior of the housing of the hearing instrument is an electric contact, which makes electrical contact with the cable regardless of the respective insertion position. The electric contact can be embodied as a sliding contact and have latching positions. The earpiece tube is mounted in the housing of the hearing instrument and the earpiece is connected by way of an end plug.

U.S. Pat. Nos. 6,173,782 B1 and 7,399,208 B2 disclose further plug connectors from other technical fields, which allow variable displacement positions and which each have a relatively complex housing configuration.

### SUMMARY OF THE INVENTION

It is accordingly an object of the invention to provide a hearing instrument with a flexible earpiece tube connection, earpiece and housing which overcomes the above-mentioned disadvantages of the prior art devices of this general type.

With the foregoing and other objects in view there is provided, in accordance with the invention a hearing system. The hearing system contains a housing, an earpiece, and an earpiece tube connected between the housing and the earpiece. The earpiece tube has a housing-side segment and an earpiece-side segment. An earpiece tube connector connects the housing-side segment of the earpiece tube to the earpiece-side segment of the earpiece tube. The earpiece tube connector forms an electrically conducting connection that is mechanically stable in respect of release and allows variable and reversible longitudinal displacement and rotation of the housing-side segment and the earpiece-side segment of the earpiece tube in relation to one another.

The object of the invention is to specify a hearing instrument to be worn behind or in or on the auricle, having an external earpiece, which is worn in the auditory canal and is connected by way of an earpiece tube to the hearing instrument housing, ensuring flexible adjustability of the earpiece tube connection both in respect of length and also in respect of rotational position while remaining compact and uncomplicated.

One basic concept of the invention consists of a hearing system, containing a housing, an earpiece, and an earpiece tube connected to the housing and the earpiece. The earpiece tube connector connects a housing-side segment of the earpiece tube to an earpiece-side segment of the earpiece tube. The earpiece tube connector configured to form an electrically conducting connection that is mechanically stable in respect of release and allows variable and reversible longitudinal displacement and rotation of the two segments of the earpiece tube in relation to one another.

Further basic concepts of the invention consist of a correspondingly embodied earpiece together with earpiece-side earpiece tube segment and earpiece-side component of the earpiece tube connector and a correspondingly embodied housing together with housing-side earpiece tube segment and housing-side component of the earpiece tube connector.

According to the basic concept of the invention therefore the earpiece tube connector, by which housing and earpiece are connected, is disposed in the earpiece tube, an arrangement referred to in other technical fields as in-line. There is therefore no need to provide a flexible connector for the earpiece tube on or in the housing. Instead the housing-side earpiece tube segment can be mounted compactly in the housing in a fixed manner. Also according to the basic concept the earpiece tube connector establishes both the electrical and the mechanical connection between the housing and the earpiece. The integration of both types of connection allows a compact and therefore also cosmetically advantageous embodiment. Such integration also facilitates handling, both during assembly and during maintenance or replacement, in particular when the electrical and mechanical connections can each be released or closed in a single handling step or action. Also according to the basic concept the earpiece tube connector is embodied as longitudinally and rotationally flexible. This improves flexible adjustment to individual needs. In particular the longitudinal variability allows adjustment to different ear sizes and auditory canal depths and the rotational variability allows adjustment to a right or left ear.

In one advantageous embodiment the electrical connection is formed by a rotationally symmetrical electrically conductive plug and a rotationally symmetrical electrically conductive socket of the earpiece tube connector, with the plug and socket being configured such that a variable and reversible depth of insertion of the plug into the socket can be achieved. This allows an uncomplicated plug principle that is simple to handle to be realized, which assists rotational and longitudinal variability.

In a further advantageous embodiment the earpiece tube connector has a number of latching positions disposed successively in the longitudinal direction of the earpiece tube, allowing the earpiece tube connector to latch in position with the segments of the earpiece tube displaced longitudinally to different degrees from one another. The latching positions allow simple handling with good tactile feedback, thereby increasing ease of use. At the same time latching positions ensure effective fixing with the respectively desired earpiece tube length.

In a further advantageous embodiment the different latching positions are each formed by a peripheral bead or groove in the earpiece-side or housing-side component of the earpiece tube connector. Peripheral beads or grooves represent a structurally simple and reliably functioning configuration of longitudinal latching positions with simultaneous rotational variability. Their mode of operation is also well known and is intuitively simple to understand, thereby increasing ease of handling.

In a further advantageous embodiment the earpiece tube connector is configured in such a manner that the connection between the two segments of the earpiece tube can be released reversibly. This allows replacement and maintenance of the earpiece in particular, without the connection between the earpiece tube and the housing of the hearing instrument having to be released for the purpose. The ability to adapt to the individual size and configuration of the ear and of the auditory canal is also increased, in that it is possible to replace different earpiece-side earpiece tube lengths and shapes. The ability to adjust to changing requirements in respect of the earpiece type and the configuration of the earpiece-side earpiece tube segment is also increased, in that it is possible to replace different earpiece types and different earpiece-side tube types.

Other features which are considered as characteristic for the invention are set forth in the appended claims.

Although the invention is illustrated and described herein as embodied in a hearing instrument with a flexible earpiece tube connection, an earpiece and a housing it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a hearing system with an earpiece tube connector according to the invention;

FIG. 2 is a side view of the hearing system with the earpiece tube on a left side;

FIG. 3 is a side view of the hearing system with the earpiece tube on the right side;

FIGS. 4-6 are side views of the hearing system with the earpiece tube having different lengths;

FIG. 7 is a perspective view of a housing with a housing-side component of the earpiece tube connector;

FIG. 8 is an illustration of the earpiece with the earpiece-side component of the earpiece tube connector;

FIG. 9 is an illustration showing the earpiece tube connector taken apart; and

FIGS. 10-12 are illustrations showing the earpiece tube connectors in different latching positions.

### DETAILED DESCRIPTION OF THE INVENTION

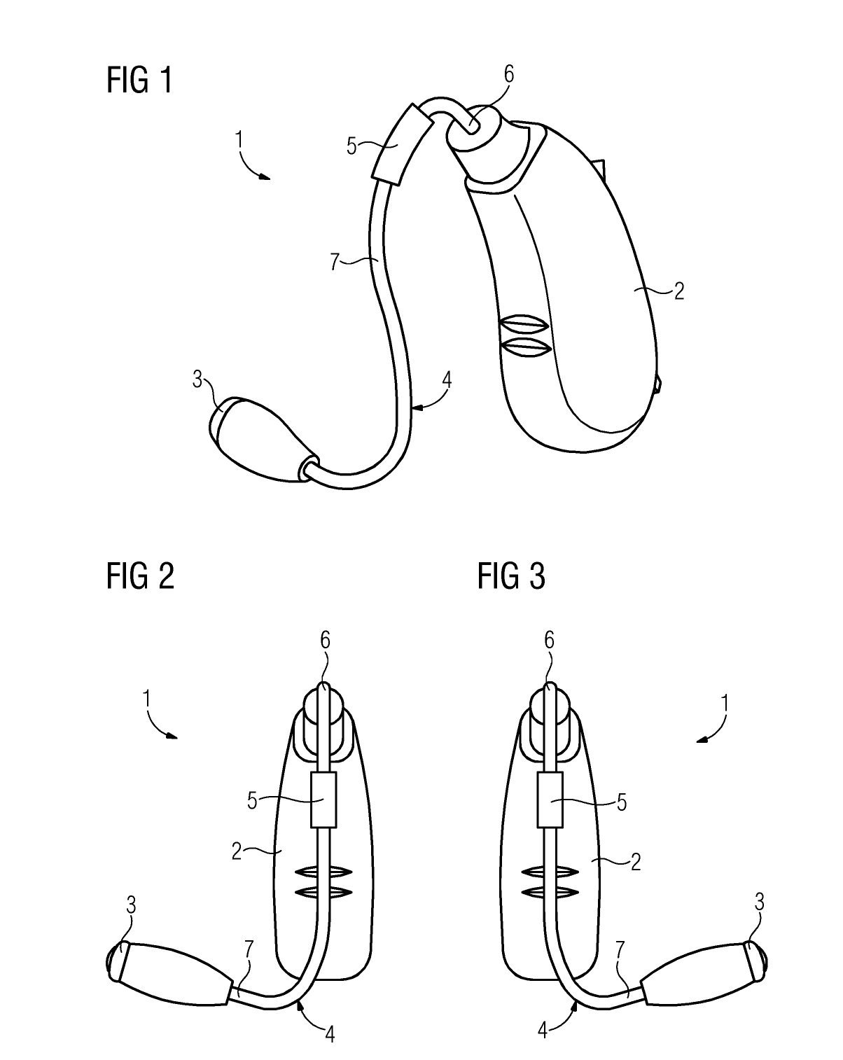

Referring now to the figures of the drawing in detail and first, particularly, to FIG. 1 thereof, there is shown a hearing system 1 with an earpiece tube connector 5. The hearing system 1 contains a housing 2, which is configured to be worn behind the ear. It is therefore a BTE device, which can be embodied for example as a hearing device.

The housing 2 is connected by way of an earpiece tube 4 to an earpiece 3. The earpiece 3 can be a conventional hearing device receiver. The earpiece tube 4 consists of a plastic sheath, which can be embodied for cosmetic reasons with a small diameter and optionally as transparent. The plastic material gives the earpiece tube 4 a certain flexibility and elasticity. Electrical lines are passed through the earpiece tube 4 in the conventional manner, connecting the earpiece 3 electrically to the housing 2 or the electronic components disposed therein, e.g. a signal amplifier.

The earpiece tube 4 has an earpiece-side segment 7 and a housing-side segment 6. The two segments 6, 7 are connected to one another by the earpiece tube connector 5. The earpiece tube connector 5 is thus disposed in-line in the earpiece tube 4.

The earpiece tube connector 5 is embodied such that it on the one hand establishes the mechanical connection between the two segments 6, 7, so that the connection cannot inadvertently be released by itself. On the other hand the earpiece tube connector 5 establishes the electrical connection for the electrical lines passed through the earpiece tube 4, in order to connect the earpiece 3 electrically to the housing 2.

The earpiece tube connector 5 is embodied such that it is mechanically stable in respect of inadvertent release of the connection between the two earpiece tube segments 6, 7 but at the same time allows rotation and longitudinal displacement of the earpiece tube-segments 6, 7 in relation to one another. In other words the earpiece-side segment 7 can be rotated in relation to the housing-side segment 6 in the earpiece tube connector 5 and can be pushed together with it or pulled apart from it.

The properties of the earpiece tube connector 5, in particular elasticity, surface friction and dimensions, influence the force required for mutual rotation or pushing together or pulling apart. This force can preferably be set based on an adjustment of the properties, such that on the one hand rotation or pushing together or pulling apart can be performed manually without particular force expenditure but on the other hand inadvertent rotation or pushing together or pulling apart is prevented.

FIG. 2 shows the hearing system 1 described above with the earpiece tube 4 on the left side. The left side here means that the earpiece-side segment 7 of the earpiece tube 5 together with the earpiece 3 is pivoted so that the hearing system 1 can be worn on the left ear of a user. The illustrated hearing system 1 contains the components described above—the housing 2, the housing-side segment 6 of the earpiece tube 7, the earpiece-side segment 4 together with the earpiece 3, and the earpiece tube connector 5. For a description of the components, reference should be made to the description above.

FIG. 3 shows the hearing system 1 described above with the component housing 2, the earpiece tube 4 and the earpiece tube connector 5 positioned on the right side. To this end the earpiece-side segment 4 of the earpiece tube together with the earpiece 3 is rotated to the right side, so that the hearing system 1 with the illustrated orientation can be worn on the right ear of a user. Rotation of the earpiece-side segment 4 and the earpiece 3 to the right in relation to the rotation to the left described above takes place reversibly here and variably in respect of the rotation angle in the earpiece tube connector 5.

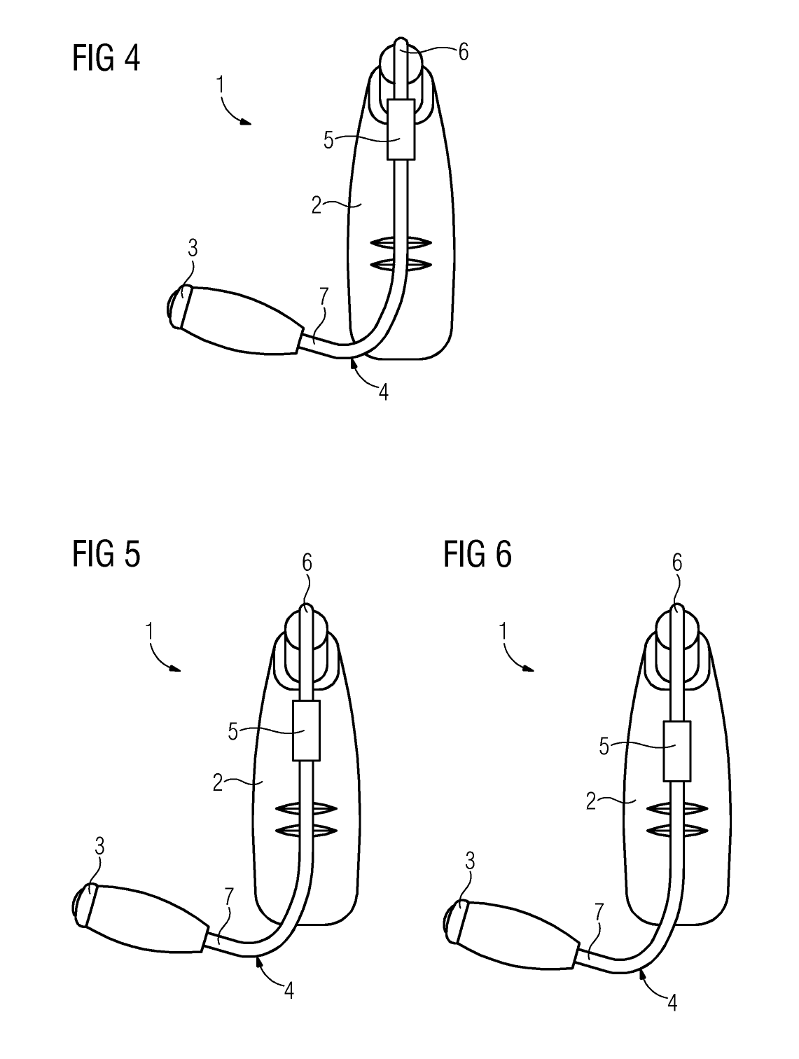

FIG. 4 shows the hearing system 1 described above with the component housing 2, the earpiece tube 4, the earpiece 3, the segments 6, 7 of the earpiece tube 4 and the earpiece tube connector 5 described above positioned on the left side again. The housing-side segment 6 of the earpiece tube 4 and the earpiece-side segment 7 are pushed together as far as possible. A variable degree of pushing together is ensured here by the earpiece tube connector 5, in other words the segments 6, 7 are pushed together by pushing the earpiece tube connector 5 together. This shortens the earpiece tube 4.

FIG. 5 shows the hearing system 1 described above again with the housing 2 and the earpiece 3 as well as the earpiece tube 4. Compared with the previous figure however the segments 6, 7 of the earpiece tube 4 are further apart in the earpiece tube connector 5. In the illustrated position the length of the earpiece tube 4 therefore assumes a medium dimension.

FIG. 6 shows the hearing system 1 described above again with the housing 2 and the earpiece 3. Compared with the previous two figures the segment 6 and the segment 7 of the earpiece tube 4 are as far apart as possible in the earpiece tube connector 5. This means that the earpiece tube 4 has its longest possible overall length.

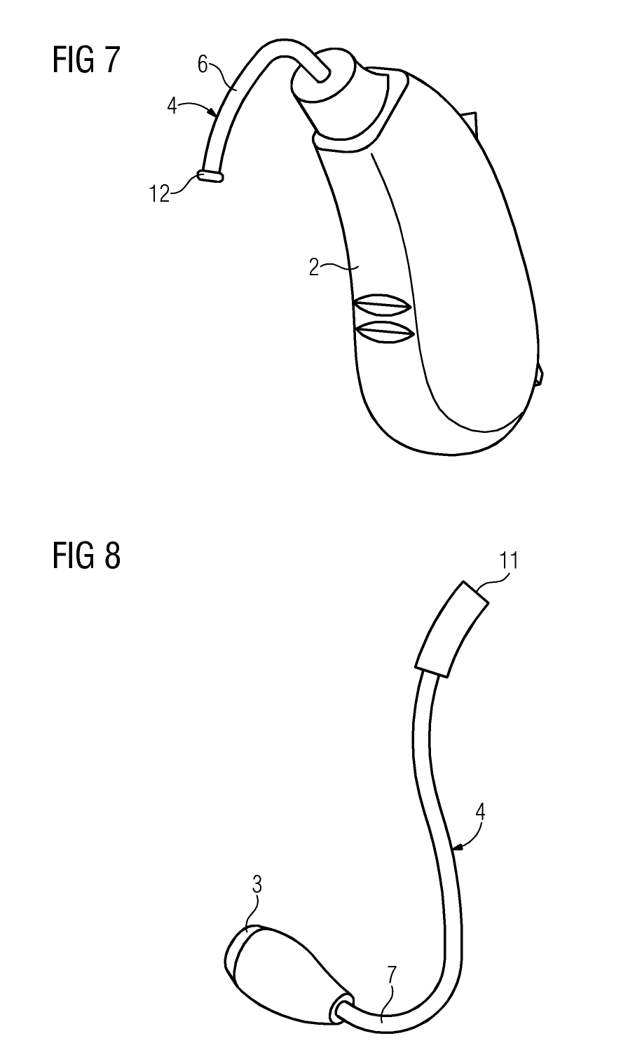

FIG. 7 shows the housing 2 of the hearing system described above. It contains the housing-side segment 6 of the earpiece tube 4, to which it is connected in a fixed manner. For example the housing-side segment 6 can be mounted and wired in a fixed manner in the housing 2. In contrast to conventional hearing instruments to be worn behind the ear, no plug or plug connector for the earpiece tube 4 is provided on or in the housing 2. Instead a housing-side component 12 of the earpiece tube connector 5 is disposed on the end of the housing-side segment 6 of the earpiece tube 4 opposite the housing 2.

To complete the hearing system, an earpiece 3 with an earpiece-side component 11 must be connected to the housing-side component 12 of the earpiece tube connector 5. The housing-side component 12 of the otherwise not illustrated earpiece tube connector 5 is embodied such that a connection can be released and established in a reversible manner. This creates a modular structure, which allows easy replacement of the separate earpiece 3 together with the earpiece-side segment 7 of the earpiece tube 3 and the earpiece-side component 11 of the earpiece tube connector 5.

FIG. 8 shows the earpiece 3 of the hearing system described above together with the earpiece-side segment 7 of the earpiece tube 4. Like the housing 2 described above together with the housing-side segment 6 of the earpiece tube 4 it serves to complete the hearing system described above.

The earpiece-side component 11 of the earpiece tube connector 5 is shown on the end of the segment 7 opposite the earpiece 3. The housing-side component 12 described above can be plugged in a reversibly releasable manner into the earpiece-side component 11, in order thus to close the earpiece tube connector 5, thereby completing the hearing system as a whole.

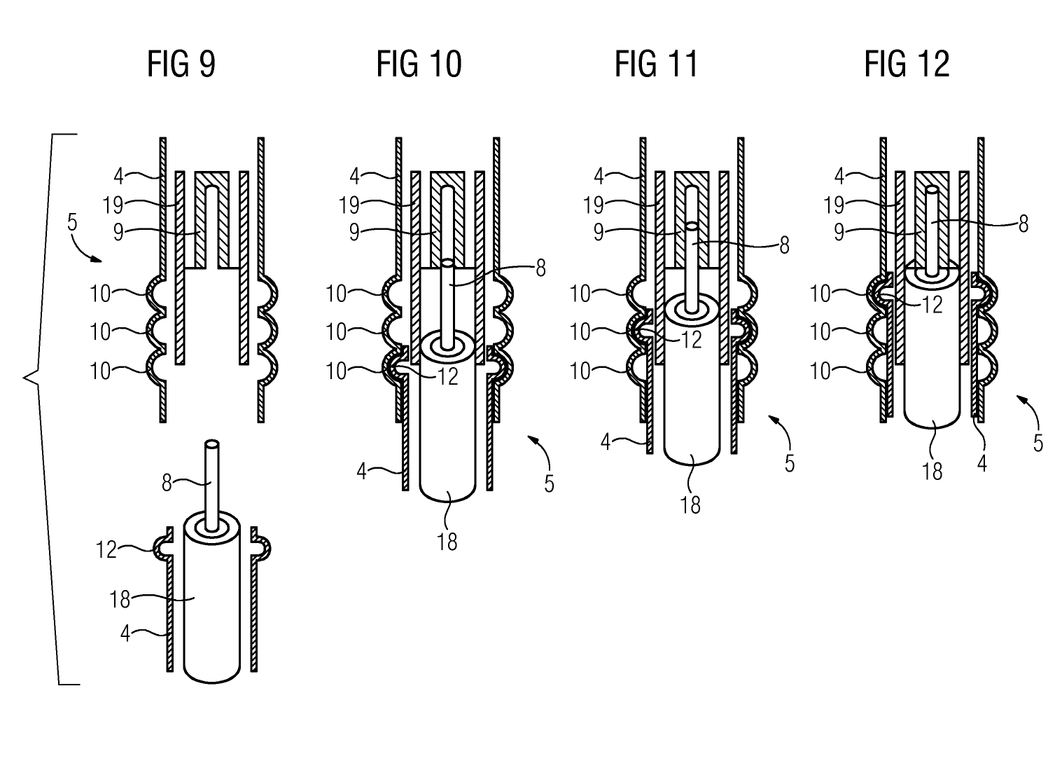

FIG. 9 shows the earpiece tube connector 5 taken apart, in other words the reversibly releasable connection is released. Each of the two components 11, 12 of the earpiece tube connector 5 here adjoins the end of the earpiece tube 4, which encloses the respective component 11, 12.

The end of the earpiece tube 4 of the component illustrated at the bottom of the figure is embodied with a peripheral bead 13. The bead 13 represents the mechanical part of the component. The electrical lines, which end in a pin-like, rotationally symmetrical plug 8 and a cylindrical, rotationally symmetrical plug 18, which is isolated electrically therefrom, are passed inside the earpiece tube 4 and the peripheral bead 13. The plugs 8, 18 form the electrical part of the component.

The electrical connections are formed by a rotationally symmetrical socket 19 and a rotationally symmetrical socket 9, which is isolated electrically therefrom, in the opposite component of the earpiece tube connector 5 shown at the top in the figure. The sockets 9, 19 are embodied and dimensioned such that they can accommodate the plugs 8, 18 and thereby establish an electrical connection. The rotational symmetry means that the two components of the earpiece tube connector 5 can be rotated in relation to one another. The longitudinal embodiment also ensures that the plug connection can be closed with variable insertion depth or connection depth.

The earpiece tube 4 of the component of the earpiece tube connector 5 shown at the top of the figure has peripheral beads 10, which succeed one another in the longitudinal direction of the earpiece tube 4. They are embodied and dimensioned such that they can accommodate the peripheral bead 13 of the respective other component. This results in three successive latching positions for the earpiece tube connector 5. The dimensions and materials of the components are selected so that the latching positions of the earpiece tube connector 5 can on the one hand be set manually without particular force expenditure but on the other hand that they form additional protection against inadvertent pulling apart or pushing together.

Because the beads 10, 13 are embodied peripherally with rotational symmetry, a variable rotational position can be set in every latching position. This allows the two components of the earpiece tube connector 5 and therefore the segments of the earpiece tube 3 connected by way thereof to be rotated in relation to one another, when the earpiece tube connector 5 is pushed together in one of the latching positions.

FIG. 10 shows the earpiece tube connector 5 described above pushed together in a first latching position. For a description of the individual components, see the description of the figures above. The illustrated latching position is the furthest apart one and therefore means that the earpiece tube 3 has its longest overall length.

It can be seen that in the first latching position mechanically stable latching is achieved in respect of the release of the earpiece tube connector 5. It can also be seen that in the illustrated first latching position contact is established between the plug 8 and the socket 9 and the plug 18 and the socket 19, so that an electrically conducting connection is closed.

FIG. 11 shows the earpiece tube connector 5 described above pushed together in a second middle latching position. For a description of the individual components, see the description of the figures above. The illustrated latching position means that the earpiece tube 3 has its medium overall length.

FIG. 12 shows the earpiece tube connector 5 described above in a third latching position pushed together to the maximum. For a description of the individual components, see the description of the figures above. The illustrated latching position represents the position in which the earpiece tube connector 5 is pushed together to the maximum, corresponding to the shortest overall length of the earpiece tube 4 described above.

1. A hearing system, comprising:
a housing;
an earpiece;
an earpiece tube connected between said housing and said earpiece, said earpiece tube having a housing-side segment and an earpiece-side segment; and
an earpiece tube connector connecting said housing-side segment of said earpiece tube to said earpiece-side segment of said earpiece tube, said earpiece tube connector forming an electrically conducting connection that is mechanically stable in respect of release and allows variable and reversible longitudinal displacement and rotation of said housing-side segment and said earpiece-side segment of said earpiece tube in relation to one another.

2. The hearing system according to claim 1, wherein said earpiece tube connector has a rotationally symmetrical electrically conductive plug and a rotationally symmetrical electrically conductive socket forming said electrically conducting connection, said rotationally symmetrical electrically conductive plug and said rotationally symmetrical electrically conductive socket being configured such that a variable and reversible depth of insertion of said rotationally symmetrical electrically conductive plug into said rotationally symmetrical electrically conductive socket can be achieved.

3. The hearing system according to claim 1, wherein said earpiece tube connector has a number of latching positions disposed successively in a longitudinal direction of said earpiece tube, allowing said earpiece tube connector to be latched in position with said housing-side segment and said earpiece-side segment of said earpiece tube and displaced longitudinally to different degrees from one another.

4. The hearing system according to claim 3, wherein said earpiece tube connector has an earpiece-side component and a housing-side component, different latching positions are each formed by one of a peripheral bead or groove formed on said earpiece-side component or said housing-side component of said earpiece tube connector.

5. The hearing system according to claim 1, wherein said earpiece tube connector is configured such that said electrically conducting connection between said housing-side segment and said earpiece-side segment of said earpiece tube can be released reversibly.

6. An earpiece system for a hearing system, the earpiece system comprising:
an earpiece-side segment of an earpiece tube, said earpiece-side segment having a first end and a second end;
an earpiece-side component of an earpiece tube connector, said earpiece-side component of the earpiece tube connector disposed at said second end of said earpiece-side segment; and
an earpiece having an end connected to said first end of said earpiece-side segment;
said earpiece-side component forming an electrically conducting connection being mechanically stable in respect of release with a housing-side component of the earpiece tube connector, allowing variable and reversible longitudinal displacement and rotation of said earpiece-side component and the housing-side component in relation to one another.

7. The earpiece system according to claim 6, wherein said earpiece-side component forming part of said electrically conducting connection, said earpiece-side component of the earpiece tube connector forming said part of said electrically conducting connection with one a rotationally symmetrical electrically conductive plug or a rotationally symmetrical electrically conductive socket, said rotationally symmetrical electrically conductive plug and said rotationally symmetrical electrically conductive socket being configured such that a plug connection can have a variable and reversible insertion depth.

8. The earpiece system according to claim 6, wherein said earpiece-side component of said earpiece tube connector has a number of peripheral beads or grooves disposed successively in a longitudinal direction of the earpiece tube and configured to allow longitudinally displaced latching positions to a varying degree of said earpiece-side component when connected to the housing-side component of the earpiece tube connector.

9. The earpiece system according to claim 6, wherein said earpiece-side component of the earpiece tube connector is configured to form a reversibly releasable connection to the housing-side component of the earpiece tube connector.

10. A housing system for a hearing system, the housing system comprising:
a housing-side segment of an earpiece tube, said housing-side segment having a first end and a second end;
a housing-side component of an earpiece tube connector, said housing-side component of the earpiece tube connector disposed at said second end of said housing-side segment; and
a housing connected to said first end of said housing-side segment of the earpiece tube;
said housing-side component configured to form an electrically conducting connection being mechanically stable in respect of release with an earpiece-side component of the earpiece tube connector, allowing variable and reversible longitudinal displacement and rotation of the earpiece-side component and said housing-side component in relation to one another.

11. The housing system according to claim 10, wherein said housing-side component forming part of said electrically conducting connection and said housing-side component of the earpiece tube connector forming said part of said electrically conducting connection with one of a rotationally symmetrical electrically conductive plug or a rotationally symmetrical electrically conductive socket, said rotationally symmetrical electrically conductive plug and said rotationally symmetrical electrically conductive socket configured such that a plug connection can have a variable and reversible insertion depth.

12. The housing system according to claim 10, wherein said housing-side component of the earpiece tube connector has a number of peripheral beads or grooves disposed successively in a longitudinal direction of the earpiece tube and configured to allow longitudinally displaced latching positions to a varying distance of said housing-side component when connected to the earpiece-side component of the earpiece tube connector.

13. The housing system according to claim 10, wherein said housing-side component of the earpiece tube connector is configured to form a reversibly releasable connection to the earpiece-side component of the earpiece tube connector.
